(19) United States
(12) Patent Application Publication
(10) Pub. No.: US 2011/0292127 A1
(43) Pub. Date: Dec. 1, 2011

(54) LIQUID DISCHARGE HEAD

(75) Inventors: Ryoji Oohashi, Yokohama-shi (JP); Yoshiyuki Imanaka, Kawasaki-shi (JP); Kazunori Masuda, Asaka-shi (JP); Daishiro Sekijima, Kawasaka-shi (JP); Takashi Aoki, Urayasu-shi (JP)

(73) Assignee: CANON KABUSHIKI KAISHA, Tokyo (JP)

(21) Appl. No.: 13/114,220

(22) Filed: May 24, 2011

(30) Foreign Application Priority Data
May 31, 2010 (JP) 2010-125114

(51) Int. Cl. B41J 2/14

(52) U.S. Cl. 347/50

(57) ABSTRACT

A liquid discharge head includes a recording element substrate having an energy generating element generating energy used to discharge liquid, a temperature detecting element changing in output voltage upon temperature change of the energy generating element, and line connection pads electrically connected to the energy generating element and the temperature detecting element; external connection pads electrically connected to the outside of the head; and an electrical wiring substrate having electrical power source line for connecting a first external connection pad connected to an external electrical power source, with the energy generating element, grounding line for connecting a second external connection pad connected to an external grounding terminal, with the energy generating element, and electrode for connecting a third external connection pad connected to an external circuit, with the temperature detecting element. The electrode in the electrical wiring substrate exists between the electrical power source line and the grounding line.

### BACKGROUND OF THE INVENTION

1. Field of the Invention

The present invention relates to a liquid discharge head which discharges liquids, such as ink.

2. Description of the Related Art

An ink jet recording apparatus having a liquid discharge head drives a heat-generating element made in a substrate of a recording head, applies heat energy to the ink within a nozzle provided in the recording head to cause foaming, and discharges the ink from the recording head by a foaming force, thereby performing recording.

In recent years, with miniaturization of the recording head and increases in the speed of recording, there have been increases in the number or density of heat-generating elements provided in a recording element substrate. Additionally, further increases in the speed of recording have been achieved by performing temperature detection of the recording element substrate, which has conventionally been performed during non-recording, during recording as well. However, a current pulse which flows to one heat-generating element reaches a high current value instantaneously. Therefore, in a case where a number of heat-generating elements are simultaneously actuated according to a recording pattern, for example, a pulsed current of about one to several amperes flows to electrical power source line and GND (grounding) line for driving the heat-generating elements instantaneously.

As such a pulsed large current flows during recording, a noise caused by inductive coupling is generated in the line in an electrical wiring substrate or a recording element substrate provided from a recording apparatus body to the recording head. Due to this noise, there is a concern that a logic circuit portion on the recording element substrate may malfunction. Additionally, radiation of unnecessary electromagnetic noise to the outside of the recording apparatus is also a cause for concern.

As a method of suppressing such a noise, as illustrated in Japanese Patent Application Laid-Open No. 2000-127400, there is a method of arranging signal lines, which are apt to be influenced by noises, inside the recording element substrate, with routing of the signal lines being suppressed to the minimum.

As described above, in recent years, the density of the heat-generating elements of the recording element substrate has been actively increased. Additionally, miniaturization of the recording head and increases in recording speed are also simultaneously required. As a result, it is necessary to detect the temperature of the recording head to perform recording control during recording, without enlarging the recording head. Accordingly, high-density line of the electrical wiring substrate, as well as the recording element substrate, is achieved, and miniaturization of the electrical wiring substrate is achieved.

However, although it is possible to control a noise inside the recording element substrate in the method described in Japanese Patent Application Laid-Open No. 2000-127400, it is difficult to control the noise on the electrical wiring substrate. Additionally, in the case of a temperature sensor, for example, a temperature detecting element using a diode, a temperature detection result is affected even if a voltage to be detected has changed only several millivolts due to a noise voltage. Therefore, the temperature detection result of the recording element substrate during recording may be greatly influenced by a noise voltage on the electrical wiring substrate generated according to a record pattern.

### SUMMARY OF THE INVENTION

Thus, the invention provides a liquid discharge head which reduces the influence that a noise voltage has on a temperature detecting element, while suppressing expansion of the area of an electrical wiring substrate.

A liquid discharge head of the invention includes a recording element substrate having an energy generating element which generates energy used to discharge a liquid, a temperature detecting element which changes in output voltage in response to a change in the temperature of the energy generating element, and a plurality of line connection pads electrically connected to the energy generating element and the temperature detecting element; a plurality of external connection pads electrically connected to the outside of the liquid discharge head; and an electrical wiring substrate having electrical power source line which is for connecting a first external connection pad connected to an external electrical power source, with the energy generating element, grounding line which is for connecting a second external connection pad connected to an external grounding terminal, with the energy generating element, and electrode which is for connecting a third external connection pad connected to an external circuit, with the temperature detecting element. Here, the electrode formed in the electrical wiring substrate is arranged between the electrical power source line and the grounding line.

According to the invention, it is possible to reduce a noise voltage detected by the temperature detecting element, and it is possible to suppress enlargement of the liquid discharge head.

Further features of the present invention will become apparent from the following description of exemplary embodiments with reference to the attached drawings.

### BRIEF DESCRIPTION OF THE DRAWINGS

FIG. 1 is an external appearance schematic view illustrating one embodiment of a liquid discharge head related to the invention.

FIG. 2 is a layout view of an electrical wiring substrate, printed wiring substrate, and recording element substrate of the present embodiment.

FIG. 3 is a layout view of one end of the recording element substrate.

FIG. 4 is a schematic configuration view of chief portions of a recording head.

FIG. 5 is a layout view of an electrical wiring substrate, printed wiring substrate, and recording element substrate of a comparative example.

FIG. 6 is a view illustrating the relationship between noise voltages generated in a temperature sensor and the driving frequency of the recording head.

FIG. 7 is another layout view of the electrical wiring substrate, the printed wiring substrate, and the recording element substrate.

FIG. 8 is still another layout view of the electrical wiring substrate, the printed wiring substrate, and the recording element substrate.

### DESCRIPTION OF THE EMBODIMENTS

An exemplary embodiment of the present invention will now be described in detail in accordance with the accompanying drawings.

In addition, the same reference numerals may be given to constituents having the same functions in the accompanying drawings, and the description thereof may be omitted.

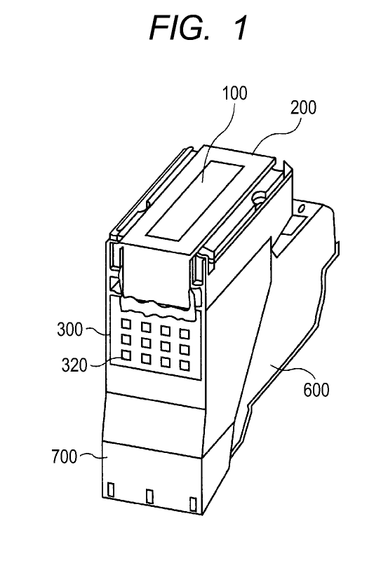

FIG. 1 is an external appearance schematic view illustrating one embodiment of a liquid discharge head related to the invention. In addition, a plate arranged on a recording element substrate 100 which is not illustrated in FIG. 1 will be described in FIG. 4.

The recording element substrate 100, and an electrical connection portion (not illustrated) with the recording element substrate 100 is provided on an electrical wiring substrate 200, and one end of the electrical wiring substrate 200 is electrically connected to a printed wiring substrate 300. Also, an external connection pad portion 320 which has a plurality of external connection pads used for electrical connection with a recording apparatus (not illustrated) is formed on the printed wiring substrate 300. In a recording head 700 of the invention, the electrical wiring substrate 200 and the recording element substrate 100, and the electrical wiring substrate 200 and the printed wiring substrate 300 are electrically connected, respectively, by ILB (inner lead bonds). Also, after the respective substrates 100, 200, and 300 are pasted on an ink holder 600, the electrical connection portion of the electrical wiring substrate 200 is sealed with a sealing agent, thereby completing the recording head 700.

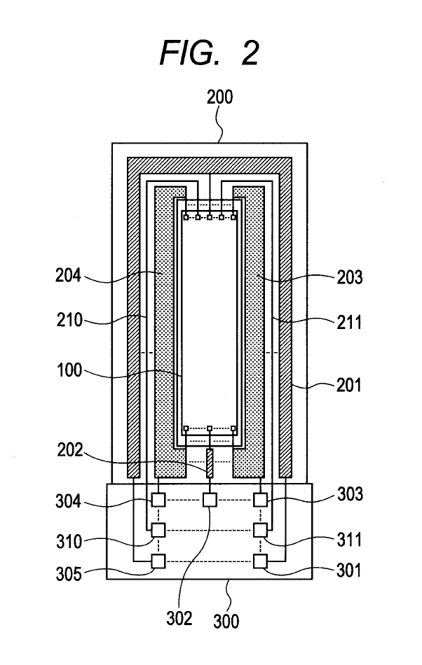

FIG. 2 is a layout view of the electrical wiring substrate, printed wiring substrate, and recording element substrate of the present embodiment. The printed wiring substrate 300 is provided with three external connection pads 301, 302, and 305 for electrical power source lines for connection with an external electrical power source (not illustrated). Additionally, two external connection pads 303 and 304 for GND (grounding) lines for connection with external grounding terminals (not illustrated) and two external connection pads 310 and 311 for electrode for connection with external circuits (not illustrated) are also provided. The two external connection pads 301 and 305 for electrical power source line on the printed wiring substrate 300 are connected together by electrical power source line 201, and the electrical power source line 201 is wired to one end of the recording element substrate 100 between the external connection pads 301 and 305 for electrical power source line on the electrical wiring substrate 200. Another external connection pad 302 for electrical power source line on the printed wiring substrate 300 is connected to the other end of the recording element substrate 100 via the electrical power source line 202. Similarly, GND lines (grounding lines) 203 and 204 are wired to both ends of the recording element substrate 100, respectively, from the external connection pads 303 and 304 for GND line on the printed wiring substrate 300 through the tops of the electrical wiring substrate 200 and printed wiring substrate 300. Additionally, electrodes 210 and 211 are wired to one end of the recording element substrate 100 from the external connection pad 310 for cathode electrode and the external connection pad 311 for anode electrode on the printed wiring substrate 300 through the tops of the electrical wiring substrate 200 and printed wiring substrate 300.

In the present embodiment, unlike the conventional structure, the two external connection pads 301 and 305 for electrical power source line are provided. Also, the electrical power source line 201 which has one end connected to the recording element substrate 100 is branched on the electrical line substrate 200, and the other end thereof is connected to the external connection pad 301 for electrical power source line, and an external connection pad 305. In addition, the two external connection pads 301 and 305 for electrical power source line are short-circuited on a circuit of a recording apparatus body (not illustrated).

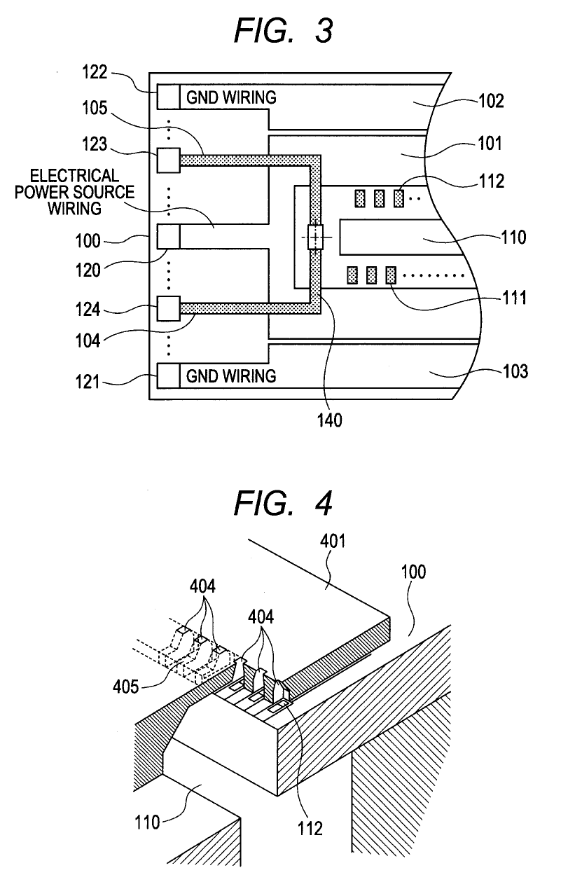

FIG. 3 is a layout view of one end of the recording element substrate 100. In addition, FIG. 2 illustrates the end of the recording element substrate opposite to the printed wiring substrate 300.

The recording element substrate 100 is formed (fabricated) using a semiconductor manufacturing technique for a silicon semiconductor substrate or the like. In the illustrated example, an ink supply port 110, which has a substantially rectangular shape and is a through hole extending in a longitudinal direction at the central portion, is formed.

Rows of a plurality of heaters 111 and 112 which are heat generating elements which generate the energy for discharging ink are provided along the longitudinal direction of the ink supply port 110. The heaters 111 and 112 heat and foam the liquid (ink) supplied from an ink tank (not illustrated) of the recording element substrate 100 via the ink supply port 110 (from the back side of the paper to the near side thereof). Also, discharge ports 404 (refer to FIG. 4) provided in the upper layer of the heaters 111 are provided to discharge droplets. Additionally, a temperature sensor (temperature detecting element) 140 for detecting the temperature of the recording element substrate 100 is provided. Although a diode is used as the temperature sensor 140 in the present embodiment, aluminum or the like may be used.

Moreover, the recording element substrate 100 is provided with a pad portion for supplying electrical power and a signal to the recording element substrate 100 through electrical line (not illustrated) from a recording apparatus body (not illustrated). The pad portion includes a plurality of line connection pads 120 to 124 for an electrical power source, GND, and a temperature detecting element, and routes line out of the recording element substrate 100 by using electrical connecting unit, such as wire contacts. Also, the pad portion performs electrical connection with a recording apparatus body (not illustrated) through the electrical wiring substrate 200 and the printed wiring substrate 300.

Additionally, the electrical power source line 101 is provided so as to surround the heaters 111 and 112, and the GND (grounding) lines 102 and 103 are provided along the longitudinal direction of the electrical power source line 101. In addition, although not illustrated, the electrical power source line 101 is connected to the heaters 111 and 112, and the GND lines 102 and 103 are also connected to the heaters 111 and 112 via a switching element or a recording element selection circuit (not illustrated).

The respective line connection pads 121 to 124 will be described. A line connection pad 123 for anode electrode connected to a temperature sensor 140 via line 105 for an anode electrode and a line connection pad 124 for cathode electrode connected to the temperature sensor via line 104 for cathode electrode are arranged on the recording element substrate 100. The respective line connection pads 123 and 124 for electrode are arranged apart from each other in such a form that the connection pads are pinched between the line connection pad 120 for electrical power source line connected to the electrical power source line 101, and the line connection pads 121 and 122 for grounding line connected to the GND lines 102 and 103, respectively. In addition, the line connection pads 120 to 124 which are adjacent to each other can be separated from each other at a substantially equal distance.

Additionally, various line connection pads for logic line are arranged between the line connection pads 120 to 124 (not illustrated in FIG. 2). In addition, the temperature sensor 140 is arranged at an equidistant position from the row of the heaters 111 and the row of the heaters 112. An insulating layer (not illustrated) is provided between each of the lines 104 and 105 for electrodes and the electrical power source line 101 such that neither the line 104 for cathode electrode or the line 105 for an anode electrode come into contact with the electrical power source line 101.

The line connection pad 120 for electrical power source line is connected to the electrical power source line 201 on the electrical wiring substrate 200, and the line connection pads 121 and 122 for GND (grounding) lines are connected to the GND lines 203 and 204 on the electrical wiring substrate 200, respectively.

FIG. 4 is a schematic configuration view of chief portions of the recording head 700.

An orifice plate 401 which has the discharge ports 404 for discharging ink, and flow channels 405 for supplying ink to the discharge ports 404 is arranged on the recording element substrate 100. The heaters 111 and 112 of the recording element substrate 100, and the discharge ports 404 are adapted to face each other, respectively. By connecting the orifice plate 401 to the above-described recording element substrate 100, it is possible to supply ink to the discharge ports 404 via the respective flow channels 405 from the ink supply port 110.

Here, the respective substrates 100, 200, and 300 when the recording head 700 performs bidirectional recording will be described with reference to FIGS. 2 and 3. Recording is performed by individually driving the row of the heaters 112 and the row of the heaters 111 in accordance with the scanning direction of the recording head 700.

Specifically, in a case where scanning of the recording head 700 is performed in the direction of the row of the heaters 112 from the row of the heaters 111, recording is performed by driving the row of the heaters 112. Additionally, in a case where scanning of the recording head 700 is performed in the opposite direction, recording is performed by driving the row of the heaters 111. In a case where the row of the heaters 111 is driven in such a driving method, a current flows to the heaters 111 from an external electrical power source (not illustrated) through the external connection pads 301, 302, and 305 for electrical power source lines, the electrical power source lines 201 and 202, and the line connection pad 120 for electrical power source line. Moreover, the current flows to a grounding terminal (not illustrated) from the heaters 111 via the GND line 103, the line connection pad 121 for GND line, the GND lines 203 and 204, and the external connection pads 303 and 304 for GND lines. Here, although described below in detail, a current flows to the electrical power source line 201 more than the electrical power source line 202, and flows to the GND line 204 more than the GND line 203. Similarly, in a case where the row of the heaters 112 is driven, a current flows to the heaters 112 from an external electrical power source (not illustrated) through the external connection pads 301, 302, and 305 for electrical power source lines, the electrical power source lines 201 and 202, and the line connection pad 120 for electrical power source line. Moreover, the current flows to a grounding terminal (not illustrated) from the heaters 112 via the GND line 103, the line connection pad 121 for GND line, the GND lines 203 and 204, and the external connection pads 303 and 304 for GND lines. Here, although described below in detail, a current flows to the electrical power source line 202 more than the electrical power source line 201, and flows to the GND line 203 more than the GND line 204.

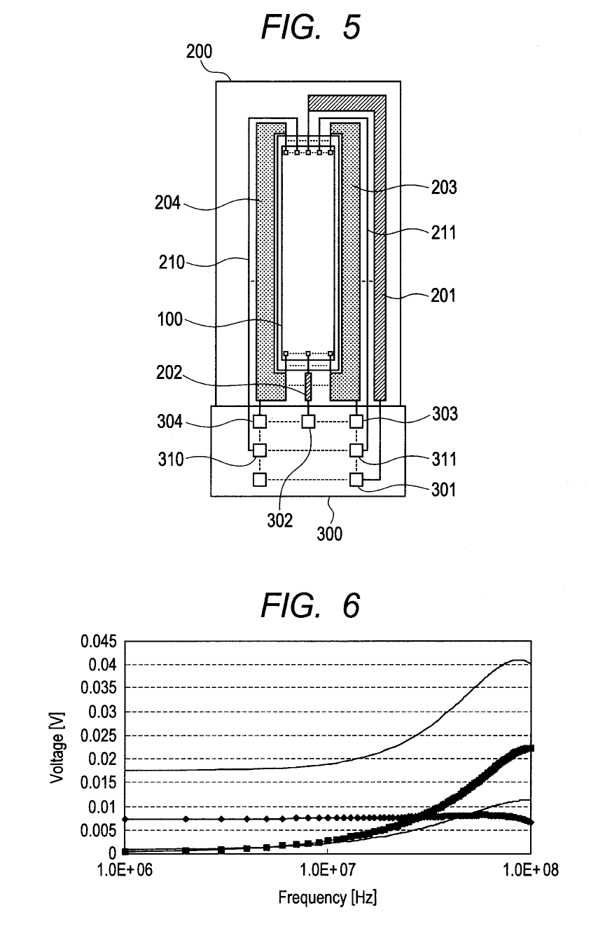

Next, a noise voltage generated in the temperature sensor of the recording head 700 of the present embodiment was measured. In addition, a recording head having the configuration of a layout view of an electrical wiring substrate, printed wiring substrate, and recording element substrate illustrated in FIG. 5 was used as a comparative example. In the present embodiment, a configuration in which the two electrodes 210 and 211 are arranged between the electrical power source line 201 and the GND lines 203 and 204, respectively, was adopted. However, in the comparative example, one electrode 211 is arranged between the electrical power source line 201 and the GND line 204. Also, there is a configuration in which the other electrical power source line 210 is arranged outside the GND line 204 and the electrical power source line 201 is not arranged outside the electrical power source line 210. Accordingly, although the electrical power source line 201 and the external connection pad 301 for electrical power source line are connected together, the electrical power source line 201 and the external connection pad 305 for electrical power source line are not connected together. Since other configurations are the same as those of the present embodiment illustrated in FIG. 2, the description thereof is omitted.

Next, the respective substrates of the present example and the respective substrates of the comparative example illustrated in FIG. 5 will be described in detail.

In the electrical wiring substrates 200 of the present example and the comparative example, a line pattern with a thickness of 25 μm is formed on a base film with a width of 15 mm and a length of 50 mm, using copper foil. The widths of the electrical power source lines 201 and 202 and the GND lines 203 and 204 on the electrical wiring substrate 200 were set to 30 μm at a narrowest portion, and were set to 1500 μm at a widest portion. Additionally, the widths of the electrodes 210 and 211 and the other logic lines (not illustrated FIGS. 2 and 5) were uniformly 30 μm. At that time, the gap between the respective lines was set to 50 μm at the narrowest portion and was set to 300 μm at the widest portion.

In addition, the distance from the centerline of each of the electrodes 210 and 211 in the width direction to the edges of the electrical power source line 201 and the GND lines 203 and 204 on the side of each of the electrodes 210 and 211 is a minimum of 200 μm and a maximum of 500 μm. In addition, the distance is 300 μm in the vicinity of a connection portion with the recording element substrate 100. In addition, the distance from the centerline of the electrode 210 in the width direction to the edge of the electrical power source line 201 on the side of the electrode 210 and the distance from the centerline of the electrode 211 in the width direction to the edge of the GND line 204 on the side of the electrode 210 are equal to each other. Additionally, the distance from the centerline of the electrode 211 in the width direction to the edge of the electrical power source line 201 on the side of the electrode 211 and the distance from the centerline of the electrode 211 in the width direction to the edge of the GND line 203 on the side of the electrode 210 are equal to each other.

In the printed wiring substrates 300 of the present example and the comparative example, line patterns with a thickness 20 μm are formed on both sides of a glass epoxy substrate with a width of 20 mm and a length of 20 mm, using copper foil, and a plurality of glass epoxy substrates is laminated. In that case, the laminated substrates are electrically connected together, using through holes with a thickness of 25 μm. Here, the widths of the electrical power source lines 201 and 202 and the GND lines 203 and 204 provided on the printed wiring substrate 300 were set to 100 μm at a narrowest portion, and were set to 2500 μm at a widest portion. Additionally, the widths of the electrodes 210 and 211 and the other logic lines (not illustrated FIGS. 2 and 5) were uniformly 100 μm. At that time, the gap between the respective lines to the external connection pads 310 and 311 for electrode was set to 100 μm at the narrowest portion and was set to 500 μm at the widest portion.

Additionally, the size of each external connection pad on the printed wiring substrate 300 is set to 2500×2500 μm, and the external connection pad is formed by forming a pattern with a thickness of 30 μm using nickel, and then, patterning gold foil with a thickness of 0.2 μm on the formed pattern.

In addition, the distance from the centerline of each of the electrodes 210 and 211 in the width direction to the edges of the electrical power source line 201 and the GND lines 203 and 204 on the side of each of the electrodes 210 and 211 is a minimum of 200 μm and a maximum of 1500 μm, and is 300 μm in the vicinity of a connection portion with the electrical wiring substrate 200. In addition, the distance from the centerline of the electrode 210 in the width direction to the edge of the electrical power source line 201 on the side of the electrode 210 and the distance from the centerline of the electrode 211 in the width direction to the edge of the GND line 204 on the side of the electrode 210 are equal to each other. Additionally, the distance from the centerline of the electrode 211 in the width direction to the edge of the electrical power source line 201 on the side of the electrode 211 and the distance from the centerline of the electrode 211 in the width direction to the edge of the GND line 203 on the side of the electrode 210 are equal to each other.

From these results, the external connection pad 311 for electrode on the printed wiring substrate 300 of FIG. 2 is arranged at a position where the distance from the external connection pad 301 for electrical power source line and the distance from the external connection pad 303 for GND line are substantially equal to each other. Similarly, the external connection pad 310 for electrode is arranged at a position where the distance from the external connection pad 305 for electrical power source line and the distance from the external connection pad 304 for GND line are equal to each other. That is, the external connection pads 310 and 311 for electrode are separated at a substantially equal distance from adjacent external connection pads.

The recording heads of the present example and the comparative example fabricated as described above performed the bidirectional recording by applying a current of 0.5 A to the external connection pads 301 and 302 for electrical power source lines, respectively, on the printed wiring substrate 300. Also, in the present embodiment and the comparative example during the bidirectional recording, noise voltages generated in the temperature sensors were compared.

In addition, in the present embodiment, since the external connection pads 301 and 305 for electrical power source line are short-circuited on the side of the recording apparatus body, the sum total of currents applied to the external connection pads 301 and 305 for electrical power source lines is 0.5 A.

The relationship between noise voltages generated in the temperature sensor and the driving frequency of the recording head is illustrated in FIG. 6. In the present embodiment, the results in a case where the row of the heaters 111 is driven are expressed by a curve 501 and the results in a case where the row of the heaters 112 is driven are expressed by a curve 502. In the comparative example, the results in a case where the row of the heaters 111 is driven are expressed by a curve 503 and the results in a case where the row of the heaters 112 is driven are expressed by a curve 504.

In the case of the recording head 700 of the present embodiment, the electrical power source line 201 is arranged outside each of the electrodes 210 and 211. Thus, the overall electrodes 210 and 211 for temperature detecting elements are arranged in such a form that the electrodes are pinched between the electrical power source line 201 and the GND lines 203 and 204. Therefore, even if any of the row of the heaters 111, and the row of the heaters 112 is driven, a current which flows to the electrical power source line 201 and a current which flows to the GND lines 203 and 204 face each other. Therefore, noise voltages are cancelled out due to the mutually facing currents.

In a case where the row of the heaters 111 is driven, the direction of a current which flows to the electrical power source line 201 on the side of the external connection pad 305 for electrical power source line, and the direction of a current which flows to the GND line 204 face each other. In this case, the current which is drawn near to the current flowing to the GND line 204 and which flows to the electrical power source line 201 is concentrated on and flows to the electrical power source line 201 on the side of the external connection pad 305 for electrical power source line more than the side of the external connection pad 301 for electrical power source line.

Similarly, in a case where the row of the heaters 112 is driven, the direction of a current which flows to the electrical power source line 201 on the side of the external connection pad 301 for electrical power source line, and the direction of a current which flows to the GND line 203 face each other. In this case, the current which is drawn near to the current flowing to the GND line 203 and which flows to the electrical power source line 201 is concentrated on and flows to the side of the external connection pad 301 for electrical power source line more than the side of the external connection pad 305 for electrical power source line.

In this manner, when the currents which flow to the respective lines face each other, electrons pull each other. For the reason, the currents which flow to the electrical power source line 201 and the GND lines 203 and 204 according to the value of the facing currents are concentrated on and flow to any one line side of the electrodes 210 and 211. Accordingly, it is possible to more effectively cancel out the noise voltages of the electrical power source line 201 and the GND lines 203 and 204.

Additionally, in the case of the present embodiment, the distance from the centerline of the electrode 210 in the width direction to the edge of the electrical power source line 201 on the side of the electrode 210 and the distance from the centerline to the edge of the GND line 204 on the side of the electrode 210 are substantially equal to each other. Additionally, the distance from the centerline of the electrode 211 in the width direction to the edge of the electrical power source line 201 on the side of the electrode 211 and the distance from the centerline to the edge of the GND line 203 on the side of the electrode 211 are substantially equal to each other. Therefore, the noise voltages generated in the electrodes 210 and 211 become equal to the noise voltages from the electrical power source line 201 and the GND lines 203 and 204, and consequently, the effect of canceling out mutual noise voltages is further enhanced.

In the case of the recording head of the above comparative example, when only the row of the heaters 112 is driven, currents flow in the directions in which the currents face the electrical power source line 201 and the GND line 203. In this case, since the directions of the currents which flow to the electrical power source line 201 and the GND line 203 face each other across the electrode 211, a noise voltage generated in the electrical power source line 201 and a noise voltage generated in the GND line 203 are cancelled out. Therefore, a noise voltage generated in the temperature sensor is small. On the other hand, when only the row of the heaters 111 is driven, the electrical power source line 201 is provided only on the electrode 211 side. Therefore, a current flows to the GND line 204 on the side of the electrode 210 from the electrical power source line 201 on the side of the electrode 211. As a result, since a portion which forms a facing current with respect to the current which flows to the GND line 204 does not exist, a noise voltage generated in the GND line 204 cannot be cancelled out. Therefore, the noise voltage generated in the temperature sensor becomes large.

From the above, the electrodes 210 and 211 between the electrical power source line 201 and the GND lines 203 and 204 are arranged, so that it is possible to suppress the noise voltage generated in the temperature sensor when the row of the heaters 111 and the row of the heaters 112 are individually driven, to a level which is satisfactory in practice. Additionally, the substrates will not be enlarged. By virtue of such a configuration, it is possible to reduce the influence of noise even when temperature detection is performed by the temperature sensor during the recording operation of discharging droplets from the liquid discharge head to perform recording. Therefore, high-precision temperature detection is possible. Additionally, unlike the related art, it is not necessary to perform temperature detection when the recording operation is not performed, and the temperature detection by the temperature sensor is always possible. It is thereby possible to raise the throughput when recording is performed.

Additionally, the external connection pad 311 for electrode on the printed wiring substrate 300 is arranged at a position where the distance from the external connection pad 301 for electrical power source line and the distance from the external connection pad 303 for GND line are substantially equal to each other. Similarly, the external connection pad 310 for electrode is arranged at a position where the distance from the external connection pad 305 for electrical power source line and the distance from the external connection pad 304 for GND line are substantially equal to each other. Therefore, there is provided a configuration in which the electrodes 210 and 211 for temperature detecting elements are pinched between the electrical power source line 201 and the GND lines 203 and 204 even on flexible wiring which electrically connects the external connection pad portion 320 (refer to FIG. 1) on the printed wiring substrate 300 and the recording apparatus body. Hence, it is possible to obtain the same effects even on line outside the recording head 700.

In addition, although the present embodiment has illustrated the configuration in which one ink supply port 110 and one temperature detecting element 140 are arranged, and one row of heaters are arranged, respectively, on both sides of the ink supply port 110, these may be plural, respectively.

Additionally, in the present embodiment, the external connection pad portion 320 is arranged in the longitudinal direction of the recording element substrate 100. However, it is possible to adopt a configuration in which the external connection pad portion is arranged in the lateral direction.

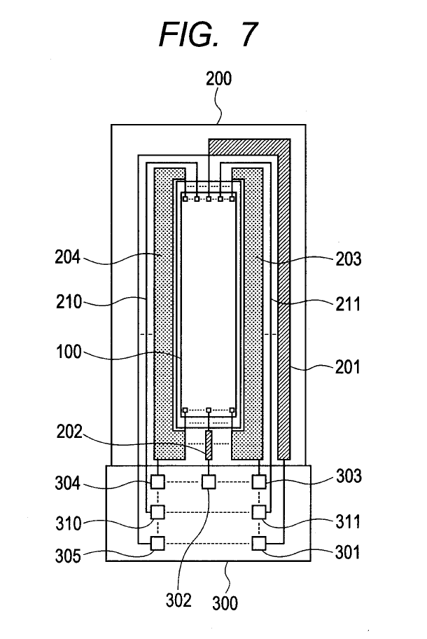

As other configurations, as illustrated in FIG. 7, a current flows so as to face the currents which flow to the GND lines 203 and 204 even if the diameter of the electrical power source line 201 may be unequal on the electrode 210 side and on the electrode 211 side. Therefore, even in a case where only the row of the heaters 111 is driven, a sufficient current flow to the electrical power source line 201 on the side of the electrode 210, and the effect of canceling out noise voltages is brought about.

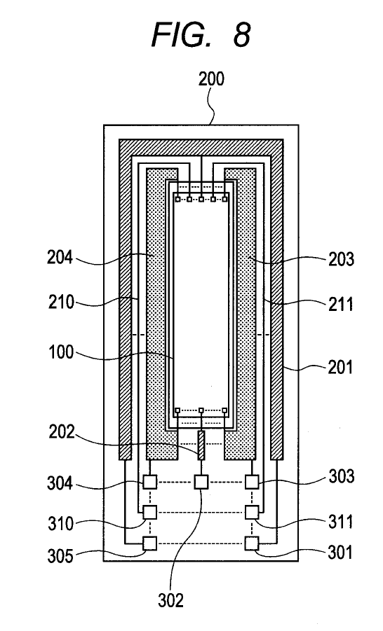

Additionally, even in a recording head having the configuration of only the electrical wiring substrate 200 using the flexible wiring substrate as illustrated in FIG. 8 without using a printed wiring substrate, it is possible to obtain the effect of canceling out noise voltages.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-125114, filed May 31, 2010, which is hereby incorporated by reference herein in its entirety.

What is claimed is:

1. The liquid discharge head comprising:
a recording element substrate having an energy generating element which generates energy used to discharge a liquid, a temperature detecting element which detects the temperature of a liquid discharge head, and a plurality of line connection pads electrically connected to the energy generating element and the temperature detecting element;
a plurality of external connection pads electrically connected to the outside of the liquid discharge head; and
an electrical wiring substrate having electrical power source line which is for connecting a first external connection pad connected to an external electrical power source, with the energy generating element, grounding line which is for connecting a second external connection pad connected to an external grounding terminal, with the energy generating element, and electrode which is for connecting a third external connection pad connected to an external circuit, with the temperature detecting element,
wherein the electrode formed in the electrical wiring substrate is arranged between the electrical power source line and the grounding line.

2. The liquid discharge head according to claim 1,
wherein one end of the electrode formed in the electrical wiring substrate is connected to the line connection pad of the recording element substrate, and the other end thereof is connected to the external connection pad.

3. The liquid discharge head according to claim 2,
wherein the plurality of line connection pads is formed at one end and other end of the recording element substrate, and the electrical power source line connects the line connection pad of the one end with the line connection pad of the other end.

4. The liquid discharge head according to claim 1,
wherein the spacing between the electrode and the electrical power source line is substantially equal to the spacing between the electrode and the grounding line.

5. The liquid discharge head according to claim 1,
wherein temperature detection is performed using the temperature detecting element during recording operation by the liquid discharge head.

6. A recording apparatus including the liquid discharge head according to claim 1.
